(19) United States
(12) Patent Application Publication
(10) Pub. No.: US 2025/0178758 A1
(43) Pub. Date: Jun. 5, 2025

(54) METHOD FOR OPERATING AN UNMANNED AIRCRAFT OF A MOTOR VEHICLE CHARGING STATION, UNMANNED AIRCRAFT, AND MOTOR VEHICLE CHARGING STATION

(71) Applicant: AUDI AG, Ingolstadt (DE)

(72) Inventor: Ralph HOLLMIG, Ingolstadt (DE)

(21) Appl. No.: 18/960,818

(22) Filed: Nov. 26, 2024

(30) Foreign Application Priority Data
Nov. 30, 2023 (DE) 102023133519.7

(51) Int. Cl. B64U 80/70; B64F 1/35; B64U 80/30; B64U 101/25; B64U 101/30

(52) U.S. Cl. CPC B64U 80/70; B64F 1/35; B64U 80/30; B64U 2101/25; B64U 2101/30; B64U 2201/20

(57) ABSTRACT

A method for operating an unmanned aircraft of a motor vehicle charging station which has at least one charging point for a motor vehicle is disclosed, and may include projecting by a projector of an aircraft, at least temporarily, an image aimed at supporting a user of the motor vehicle onto a projection surface. An unmanned aircraft for a motor vehicle charging station and a motor vehicle charging station are further disclosed.

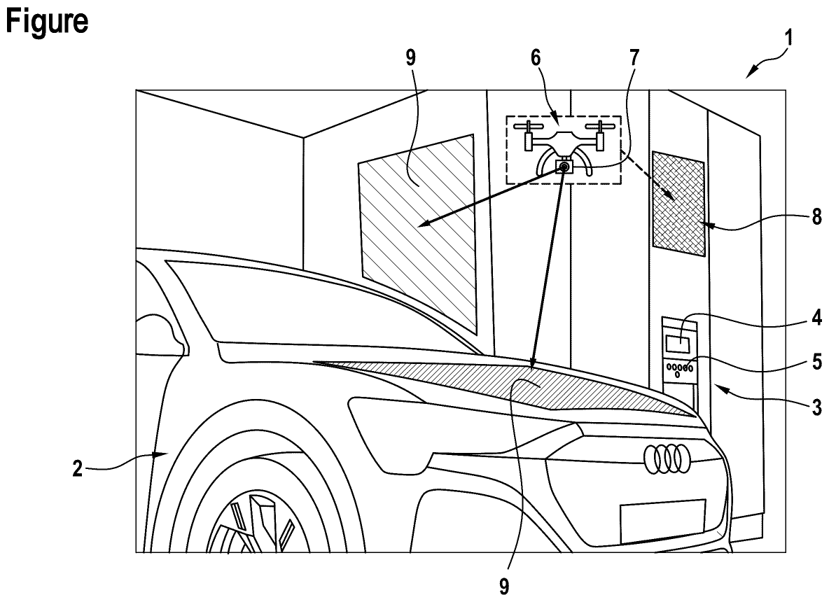

### BACKGROUND

### Technical Field

The disclosure relates to a method for operating an unmanned aircraft of a motor vehicle charging station, a corresponding unmanned aircraft, and a motor vehicle charging station.

### Description of the Related Art

US 2022/0089147 A1 describes an information processing apparatus including a controller configured to perform: obtaining information for associating a parking slot in which a user has parked with the user; obtaining information about a sign of the user returning to the parking slot; and making another user waiting to park aware of a position of the parking slot when the user obtains the information about the sign of the user returning to the parking slot.

### BRIEF SUMMARY

The present disclosure provides a method for operating an unmanned aircraft of a motor vehicle charging station, which has advantages over known methods, including by offering a user of the motor vehicle targeted support, preferably for a charging process of an energy storage device of the motor vehicle at the motor vehicle charging station.

According to the disclosure this may be achieved with a method for operating an unmanned aircraft of a motor vehicle charging station. In some embodiments, the aircraft may project, at least temporarily, an image aimed at supporting a user of the motor vehicle onto a projection surface by way of a projector.

The exemplary embodiments explained in the description are not limiting; rather, any variations of the features disclosed in the description, the claims and the FIGS. may be implemented.

The method is used to operate the unmanned aircraft. The unmanned aircraft is also commonly referred to as a “drone” and may preferably be in the form of an aircraft that operates autonomously or at least partially autonomously, such that the aircraft may be configured to maintain its position autonomously or partially autonomously over a certain period of time. The aircraft may be an aircraft that is heavier than air and has a power drive. In this respect, the aircraft may be, for example, a helicopter or a multicopter. With regard to its classification into technical classes according to EASA, the aircraft may fall into class C2 at most, preferably class C1 at most. The multicopter may be, for example, a tricopter, quadrocopter, hexacopter or octocopter.

The aircraft may preferably be equipped with an electric drive, for example, with one or more electric motors. The electric motor may be a brushless direct current motor (BLDC) which is electronically commutated. The electric drive may be supplied with electrical energy from an electrical energy storage device, the energy storage device being on board the aircraft. In addition, the aircraft may preferably have one or more of the following devices: satellite navigation device, inertial navigation device, altimeter device, and compass.

The aircraft may preferably be part of the motor vehicle charging station, but may also be present and/or operated separately from the motor vehicle charging station. The motor vehicle charging station may be configured for charging an energy storage device of a motor vehicle. In this respect, the motor vehicle may be a motor vehicle that runs at least temporarily on electricity, and may run purely on electricity. To charge the motor vehicle or its energy storage device, the motor vehicle charging station has at least said one charging point, i.e., exactly one charging point or multiple charging points. At each charging point, a device is available by way of which a motor vehicle can be charged.

At each charging point of the motor vehicle charging station, the motor vehicle charging station provides electrical energy for charging the motor vehicle or a motor vehicle. If this description refers to the at least one charging point or the charging point, the statements are always equivalent and transferable to one another. Preferably, the statements are also transferable to each of the multiple charging points of the motor vehicle charging station, if available.

Preferably, the motor vehicle charging station or its charging point may be configured for rapid charging of the motor vehicle. Since the motor vehicle charging station is not necessarily connected to a power grid that can provide sufficient electrical power for multiple charging points at any time, the motor vehicle charging station may preferably have an electrical buffer. This buffer may have, for example, a capacity of at least 0.5 MWh, at least 0.7 MWh or at least 0.9 MWh. In some embodiments, the energy storage device may be associated with the charging point, so that in the case of multiple charging points, each of the charging points has such an energy storage device. However, it may also be provided that several of the charging points are electrically connected to a common buffer. In any case, this ensures that sufficient charging power is available for the motor vehicle.

An electrical connection of the motor vehicle to the charging station for charging may be made by wire or wirelessly. In the former case, preferably a continuous conductive electrical connection of the motor vehicle may be established to the charging station, and in the latter case, the connection may be inductive, at least in sections. The conductive connection may be provided, for example, via a charging cable that is electrically connected to the motor vehicle by way of a plug connection. The charging cable may preferably be arranged on a movable charging arm that guides the charging cable in a pivotable manner. The charging arm may preferably have an electric drive that moves the charging cable in the direction of a charging connection of the motor vehicle and/or in a direction specified by the user. This may make establishing the electrical connection between the motor vehicle and the motor vehicle charging station significantly easier.

Since motor vehicles are relatively complex in design and in operation, the motor vehicle charging station may be configured with an assistance device. This assistance device may comprise the aircraft, which is operated at least temporarily to support the user of the motor vehicle. The aircraft may have the projector, by way of which the aircraft projects the image aimed at supporting the user onto the projection surface, at least temporarily. This means that the image may be generated, for example by the aircraft and/or at a central location connected to the aircraft via a communication link, and is then output using the projector.

The term projector is understood to mean, in principle, any optical device by way of which an image can be projected. For example, the projector may be in the form of a video projector or a laser projector. In any case, the projector may be configured to project various images; in this regard, the image may not be static but can be subject to change. For example, the projector may have a light source and an image converter, such as an integrated circuit, including a liquid crystal display (LCD) or a digital multimirror device (DMD).

The projection surface onto which the projector projects the image may also be chosen arbitrarily in principle. However, the image may be arranged, dimensioned and aligned in such a way that the user can readily see the image and thus the aircraft effectively supports the user. In principle, it would be possible to project the image using a stationary projector, which may be arranged on the roof of the vehicle charging station, for example. However, as a large number of different vehicles use the vehicle charging station, such a solution may not provide sufficient flexibility.

Simply using the aircraft to position the projector may ensure a satisfactorily free positioning, so that adaptation to different motor vehicles may occur. This may be particularly important if the projection surface is partially or completely on the motor vehicle. This may be the only way to reliably ensure that the projector may provide targeted support to the user for a large number of different motor vehicles, which may also be positioned differently in relation to the vehicle charging station.

In some embodiments, the motor vehicle charging station may have a hangar for the aircraft and that the aircraft may be steered from the hangar in the direction of the motor vehicle and/or the user in the event of a request for support. The aircraft may therefore be in the hangar until the request for support occurs. Said aircraft may preferably be supplied with electrical energy there in order to charge an energy storage device of the aircraft. Only when the request for support occurs, the aircraft is put into operation and steered from the hangar to the motor vehicle or its user. Preferably, the hangar may be lockable, for example by a hangar door, which may be configured as a roller door or a folding door. The hangar door may normally be closed, such that no access to the aircraft is permitted from outside the hangar. The hangar door may only be opened for the purpose of the aircraft leaving the hangar, for example in the event of the request for support.

The motor vehicle charging station may have multiple aircraft, each of which may be configured analogously to the aircraft described. Said multiple aircraft may be arranged in a common hangar or in several hangars, at least temporarily. For example, each of the charging points may be associated with a hangar with an aircraft in it. When the motor vehicle is arranged at one of the charging points and the request for support occurs, the aircraft associated with the charging point may be steered in the direction of the motor vehicle or the user. However, if the battery charge level of the aircraft is too low, one of the other aircraft may be used. In any case, reliable support for the user is implemented in this way.

In some embodiments, the request for support may be triggered by the user or after a certain period of inactivity. The request for support may be triggered in different ways. On the one hand, the request for support may be triggered by the user themselves, for example via a control element of the motor vehicle charging station and/or by way of a mobile device, such as a cell phone, a tablet or the like. In some embodiments, the request for support may be triggered if inactivity is detected over a certain period of time. Inactivity is understood to mean, for example, parking the motor vehicle at the charging point without any further actions being taken, including charging the motor vehicle. In this case, it is assumed that the user needs support for charging and the request for support may be triggered. This reliably ensures that the user receives sufficient support.

In some embodiments, one of the following surfaces may be used as a projection surface: a wall surface of the motor vehicle charging station, a floor surface of the surroundings of the motor vehicle, a body surface of the motor vehicle, and an interior surface of the motor vehicle. The image may be projected onto the projection surface using the aircraft's projector. Said projection surface may be available entirely or at least partially on one of the surfaces mentioned. For example, the wall surface of the motor vehicle charging station may be used, wherein the wall surface may be a vertical wall surface. For example, the wall surface may be configured to reflect light, such as by way of a light-reflecting coating.

The floor surface on which the motor vehicle is parked may also be used as a projection surface. For example, a part of the floor surface may be used as a projection surface, which is configured to reflect light, such as by applying a light-reflecting coating to the floor surface. Furthermore, the body surface of the motor vehicle itself may be used as a projection surface. The body surface may be, for example, on a hood, a trunk lid or on a door of the motor vehicle. The motor vehicle may automatically move one of the elements mentioned to provide the projection surface by way of an actuator.

Additionally or alternatively to the body surface, the interior surface may be used as a projection surface. The interior surface is understood to mean a surface in the interior of the motor vehicle, such as in a passenger compartment of the motor vehicle, a luggage compartment of the motor vehicle, or an engine compartment of the motor vehicle. In this respect, for example, an inside of the hood may have the interior surface. An area of the dashboard may also be used as an interior surface. This can provide targeted support for technical questions, for example by displaying technical instructions, preferably step by step, on the projection surface.

When projecting the image onto the projection surface, a geometry of the projection surface may be taken into account. This may particularly be important if the projection surface is on the motor vehicle, since an outer shell of the motor vehicle is usually not flat. The geometry of the projection surface used may be stored for different motor vehicles and, after the motor vehicle has been identified by the aircraft or the motor vehicle charging station, the stored geometry may be used as a reference when projecting the image. Alternatively, the geometry of the projection surface may be determined by the projector or the aircraft itself, such by a device suitable for this purpose, for example a laser scanner. This ensures that the image can be clearly recognized by the user, regardless of the choice of projection surface.

In some embodiments, the motor vehicle may be connected to the motor vehicle charging station and/or the aircraft via a data link and may provide the projection surface on request by moving a motor vehicle component. The motor vehicle component may be, for example, the hood, a trunk lid, a door, a tank cap or tank cover or the like. A tank cap is also understood to mean a cover for an electrical charging connection. If the aircraft requires a certain projection surface but this projection surface is not currently available, this may be communicated to the motor vehicle via the data link. The motor vehicle may then move the motor vehicle component to provide the projection surface. For example, the inside of the hood may be utilized in this way as a projection surface to support the user in a targeted manner and at the location of an action to be carried out.

In some embodiments, the aircraft may project the image to implement one of the following functions: guiding the motor vehicle to the charging station, providing the user with an instruction for a usage action of the motor vehicle, and providing the user with an instruction for charging an energy storage device of the motor vehicle by way of the motor vehicle charging station. Initially, the aircraft may therefore be used to navigate the motor vehicle or its user to the charging point.

Such an approach may be particularly important if the motor vehicle charging station has multiple charging points. In this case, the motor vehicle charging station selects one of the charging points when the motor vehicle arrives and the aircraft projects the image so that the user of the motor vehicle can steer the motor vehicle to the selected charging point. The image in this case may comprise navigation instructions, for example in the form of a pictogram, which are projected onto the projection surface. The body surface of the motor vehicle, for example the hood, or the floor surface of the motor vehicle's surroundings may be used as a projection surface.

Furthermore, the image may be projected to provide the user with the instruction. The instruction may be used to implement the usage action, for example opening the tank cap, the hood or the like. For example, the aircraft may use the projected image to demonstrate steps that are necessary to reach a certain goal or to implement the usage action. For this purpose, the aircraft may detect work steps that the user has already carried out and may adapt the image accordingly. Additionally or alternatively, the projected image may be used to provide the user with the instruction for charging the energy storage device. For example, a step-by-step instruction may be provided to electrically connect the motor vehicle to the charging point or the motor vehicle charging station in order to charge the energy storage device. This may enable the motor vehicle charging station particularly easy to use.

Other areas of use for the aircraft are also conceivable and may be implemented, additionally or alternatively, at least temporarily. For example, a test vehicle may be available for a test drive at the motor vehicle charging station. The user of the motor vehicle may therefore utilize the time in which their motor vehicle is being charged to test drive the test vehicle. On the one hand, it can be provided that the aircraft shows the user the way to the test vehicle, again by projecting the image, and highlights the test vehicle to be used by way of a marker if multiple test vehicles are available. Additionally or alternatively, the aircraft may be utilized to produce an image recording, such as a video recording, of the user during the test drive. For this purpose, the aircraft may move with the test vehicle, for example in a defined relative position of the vehicles to one another, and may record the user in the test vehicle.

In some embodiments, the aircraft may have at least one of the following devices: a screen, by way of which at least temporarily a further image is displayed, a loudspeaker, by way of which at least temporarily an output sound signal is output, a microphone, by way of which at least temporarily an input sound signal is recorded, and a camera, by way of which at least temporarily a recording is taken. In addition to the projector, the aircraft may therefore have, for example, the screen. The further image may be output at least temporarily using the screen. For example, simultaneously the image may be displayed using the projector and the further image may be displayed using the screen. A human assistant or an avatar of the assistant may be displayed using the screen, while the projector may be used to present the instructions. This may create an emotional bond with the user.

The additionally or alternatively provided loudspeaker may be used to output the output sound signal at the location of the aircraft. For example, the output sound signal may contain an acoustic instruction for the user, or communication with the assistant may be implemented using the loudspeaker. The microphone, which may be used to record the input sound signal, also preferably serves this purpose. For example, the microphone and loudspeaker may both be used for communication with the assistant, so that a voice connection may be established between the assistant and the user of the motor vehicle.

Furthermore, the aircraft may have the camera. The camera may be used to take a recording, for example a recording of the motor vehicle, at least temporarily. This may be used, for example, to identify the motor vehicle and to provide support to the user depending on the motor vehicle. Other areas of use for the camera have already been mentioned. The camera may also be used to record areas of the motor vehicle that are difficult to access. The recordings may then be displayed to the user of the motor vehicle using the image or the further image or using another display device. This may allow the user to thoroughly inspect their motor vehicle without physical exertion and without the risk of soiling their clothing.

In some embodiments, the aircraft may communicate with a central station via a communication connection, which central station may provide the image and/or the further image and/or the output sound signal and/or evaluates the input sound signal and/or the recording. The aircraft may be, for example, semi-autonomous in this respect. The central station may specify a target position for the aircraft and the aircraft may move to this target position independently. However, the interaction of the aircraft with the user may be specified or taken over by the central station. For this purpose, the aforementioned signals may be provided or evaluated. This may result in particularly targeted support for the user.

In some embodiments, the motor vehicle and/or the user may be recorded at least temporarily by way of a further camera which is arranged in the motor vehicle charging station. The further camera may be used, for example, to identify the motor vehicle or a type of the motor vehicle. The further camera may also be used to precisely determine the position of the aircraft, such as a relative position of the aircraft to the motor vehicle and/or the user. Consequently, particularly reliable navigation of the aircraft may be implemented.

The disclosure furthermore relates to an unmanned aircraft for a motor vehicle charging station, which may be configured to carry out the method according to the statements in the context of this description, wherein the motor vehicle charging station has at least one charging point for a motor vehicle. The aircraft may be configured to project, at least temporarily, an image aimed at supporting a user of the motor vehicle onto a projection surface by way of a projector.

The advantages of such a configuration of the aircraft or such an approach have already been described. Both the aircraft and the method for operating it can be refined according to the statements in the context of this description, so reference is made to these statements in this respect.

The disclosure also relates to a method for operating a motor vehicle charging station with at least one charging point for a motor vehicle and an unmanned aircraft according to the statements in this disclosure. In this case, it is provided that the aircraft may project, at least temporarily, an image aimed at supporting a user of the motor vehicle onto a projection surface by way of a projector.

Finally, the disclosure relates to a motor vehicle charging station with at least one charging point for a motor vehicle and an unmanned aircraft, such as an aircraft according to the statements in this description and/or for carrying out the method also explained. The aircraft may be intended and configured to project, at least temporarily, an image aimed at supporting a user of the motor vehicle onto a projection surface by way of a projector.

The features and combinations of features described in the description, in particular the features and combinations of features described in the following description of the FIGS. and/or shown in the FIGS., can be used not only in the combination specified in each case, but also in other combinations or on their own, without departing from the scope of the disclosure. Thus, embodiments are also to be regarded as being encompassed by the disclosure that are not explicitly shown or explained in the description and/or the FIGS., but which emerge from the embodiments explained or can be derived from them.

### BRIEF DESCRIPTION OF THE SEVERAL VIEWS OF THE DRAWINGS

The FIGURE shows a schematic representation of a motor vehicle charging station and a motor vehicle located at the motor vehicle charging station.

### DETAILED DESCRIPTION

The FIGURE shows a schematic representation of a motor vehicle charging station 1 and a motor vehicle 2 which is arranged at a charging point 3 of motor vehicle charging station 1. Motor vehicle charging station 1 may have a display device 4 and an operating device 5 at charging point 3, which are preferably height-adjustable, which may be automatic. For example, display device 4 and operating device 5 may be height-adjustable independently of one another. Motor vehicle charging station 1 may have an unmanned aircraft 6, which here is in the form of a multicopter, for example a quadrocopter.

Aircraft 6 may have a projector 7, which may be arranged on an underside of aircraft 6. Projector 7 may be arranged pivotably on aircraft 6 or a base body of aircraft 6. For this purpose, the projector 7 may be connected to the base body via an actuator. Furthermore, motor vehicle charging station 1 may have a hangar 8 for aircraft 6. Hangar 8 may be located, for example, above display device 4 and may be lockable. For this purpose, hangar 8 may have, for example, a hangar door.

Aircraft 6 may project, at least temporarily, an image onto a projection surface 9, using projector 7. Two different projection surfaces 9 are indicated here purely as an example, namely a wall surface of motor vehicle charging station 1 and a body surface of motor vehicle 2. The body surface here is—for example—an outside of a hood. However, other surfaces may also be used as a projection surface 9, for example a floor surface of surroundings of the motor vehicle and/or an interior surface of motor vehicle 2.

A user of motor vehicle 2 may be provided with support in a targeted manner using aircraft 6. The support may, for example, be aimed at navigating motor vehicle 2 to charging point 3 and/or carrying out a charging process of motor vehicle 2 at charging station 3. In this case, the user may be provided with step-by-step instructions, for example, which are displayed in the form of an image on projection surface 9. An image corresponding to a first work step in a sequence of steps may initially be displayed. The execution of the work step may preferably be monitored by aircraft 6. Only when it is determined that the user has carried out the work step, an image corresponding to a second work step may be projected. If, however, it is determined that the user remains in the first work step for too long, the image may be changed to make the instruction more specific and/or contact may be made with a human assistant.

Other areas of application for aircraft 6 are also conceivable. On the one hand, actions of the user could be recorded, for example by way of a camera of aircraft 6, in order to be able to offer support in a targeted manner. It may also be evaluated how users actually carry out certain actions, for example charging motor vehicle 2. Instructions for maintenance of motor vehicle 2 may also be provided by working through different points on a checklist. This means that projector 7 may project multiple images one after the other, each of which is aimed at a specific instruction in order to have motor vehicle 2 checked by the user. It is also possible to use aircraft 6 to fly to specific places on motor vehicle 2 in a targeted manner and to record them using the camera. The recordings obtained in this way may then be evaluated in order to identify any defects at an early stage. This may reduce the maintenance requirements for motor vehicle 2.

If aircraft 6 is not being utilized to support the user of motor vehicle 2, it may be used to observe the surroundings. For example, aircraft 6 may move on a predetermined path around motor vehicle charging station 1 in order to detect and indicate unauthorized actions. A movable charging arm of motor vehicle charging station 1, via which motor vehicle 2 is charged, may be checked. For this purpose, for example, aircraft 1 may be moved to a certain position and the charging arm may be recorded using the camera. The charging arm may then be controlled for displacement. If the camera does not detect any or insufficient displacement of the charging arm, an error may be reported to motor vehicle charging station 1. This provides aircraft 6 with an extremely high level of flexibility.

German patent application no. 102023133519.7, filed Nov. 30, 2023, to which this application claims priority, is hereby incorporated herein by reference, in its entirety.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A method for operating an unmanned aircraft of a motor vehicle charging station having at least one charging point for a motor vehicle, comprising:
projecting by a projector of the aircraft, at least temporarily, an image aimed at supporting a user of the motor vehicle onto a projection surface.

2. The method according to claim 1, wherein the motor vehicle charging station includes a hangar for the aircraft, and
the method further comprising:
steering the aircraft from the hangar in the direction of the motor vehicle and/or the user in response to a request for support.

3. The method according to claim 1, wherein any of a wall surface of the motor vehicle charging station, a floor surface of the surroundings of the motor vehicle, a body surface of the motor vehicle, and an interior surface of the motor vehicle is used as the projection surface.

4. The method according to claim 1, further comprising:
providing the projection surface by the motor vehicle on request by displacing a motor vehicle component,
wherein the motor vehicle is connected to the motor vehicle charging station and/or the aircraft via a data link.

5. The method according to claim 1, wherein the aircraft projects the image to implement any of guiding the motor vehicle to the charging station, providing the user with an instruction for a usage action of the motor vehicle, and providing the user with an instruction for charging an energy storage device of the motor vehicle by way of the motor vehicle charging station.

6. The method according to claim 1, wherein the aircraft includes at least one of a screen, a loudspeaker, a microphone, and a camera,
wherein the screen is configured to display a further image, at least temporarily,
wherein the loudspeaker is configured to output an output sound signal, at least temporarily,
wherein the microphone is configured to record an input sound signal, at least temporarily, and
wherein the camera is configured take a recording, at least temporarily.

7. The method according to claim 1, wherein the aircraft is configured to communicate via a communication link with a central location, wherein the central location provides the image, the further image, and/or the output sound signal, and/or evaluates the input sound signal and/or the recording.

8. The method according to claim 1, further comprising:
at least temporarily recording the motor vehicle and/or the user by way of a further camera arranged at the motor vehicle charging station.

9. An unmanned aircraft for a motor vehicle charging station, comprising:
a projector configured to project, at least temporarily, an image aimed at supporting a user of the motor vehicle onto a projection surface,
wherein the motor vehicle charging station has at least one charging point for a motor vehicle.

10. A motor vehicle charging station comprising:
at least one charging point for a motor vehicle; and
an unmanned aircraft including a projector configured to project, at least temporarily, an image aimed at supporting a user of the motor vehicle onto a projection surface.
